(19) United States
(12) Patent Application Publication
(10) Pub. No.: US 2008/0083485 A1
(43) Pub. Date: Apr. 10, 2008

(54) Method for making a shoe

(76) Inventor: Cheng-Hsian Chi, Taichung City (TW)

Correspondence Address: LADAS & PARRY LLP, 26 WEST 61ST STREET, NEW YORK, NY, 10023, US

(21) Appl. No.: 11/542,825

(22) Filed: Oct. 4, 2006

(51) Int. Cl. B29D 31/50; B29C 65/18

(52) U.S. Cl. 156/245; 264/244

(57) ABSTRACT

A method for making a shoe includes the steps of: a) placing a foamed sole blank and an upper in a mold, the upper being superimposed on the sole blank and having a last inserted therein; b) heating the mold to a temperature ranging from 110 to 150° C. so that the sole blank is softened and bonded to the upper, and so that the sole blank is formed into a shape of a sole of the shoe; and c) cooling the mold. The sole blank is larger than the sole by a volume of 12-45%.

### BACKGROUND OF THE INVENTION

1. Field of the Invention

The invention relates to a method for making a shoe, more particularly to a method for making a shoe in which a sole blank of the shoe can be assembled with an outsole and an upper of the shoe by direct thermal-molding.

2. Description of the Related Art

U.S. Pat. No. 4,960,374 relates to an apparatus for molding outer and inner soles and a sole welt onto shoe uppers. A molded outer sole is formed by injection molding plasticized thermoplastic material into a first mold cavity. A molded sole welt is formed on a last supported shoe upper by injection molding plasticized thermoplastic material into a sole welt mold cavity. A molded inner sole is formed by injection molding foamed plasticized thermoplastic material into an inner sole mold cavity. However, the injection molding technique involves a complicated mold venting system, and is susceptible to problems relating to the molding pressure applied to the mold, and the molding temperature.

### SUMMARY OF THE INVENTION

Therefore, the object of the present invention is to provide a method for making a shoe integrally, in which a sole blank of the shoe is disposed in a mold together with an upper of the shoe so as to be assembled integrally into a shoe by thermal molding.

According to this invention, the method for making a shoe includes the steps of: a) placing a foamed sole blank and an upper in a mold, the upper being superimposed on the sole blank and having a last inserted therein; b) heating the mold to a temperature ranging from 110 to 150° C. so that the sole blank is softened and bonded to the upper, and so that the sole blank is formed into a shape of a sole of the shoe; and c) cooling the mold. The sole blank is larger than the sole by a volume of 12-45%.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart of the preferred embodiment of a method for making a shoe according to this invention;

FIG. 2 is an exploded perspective view illustrating how a shoe is made according to the preferred embodiment, in which an outsole is a singular outsole component;

FIG. 3 is a sectional view showing a molding stage of the preferred embodiment; and

FIG. 4 is an exploded perspective view illustrating how a shoe is made according to the preferred embodiment, in which an outsole is composed of two separate outsole components.

### DETAILED DESCRIPTION OF THE PREFERRED EMBODIMENT

Before the present invention is described in greater detail, it should be noted that like elements are denoted by the same reference numerals throughout the disclosure.

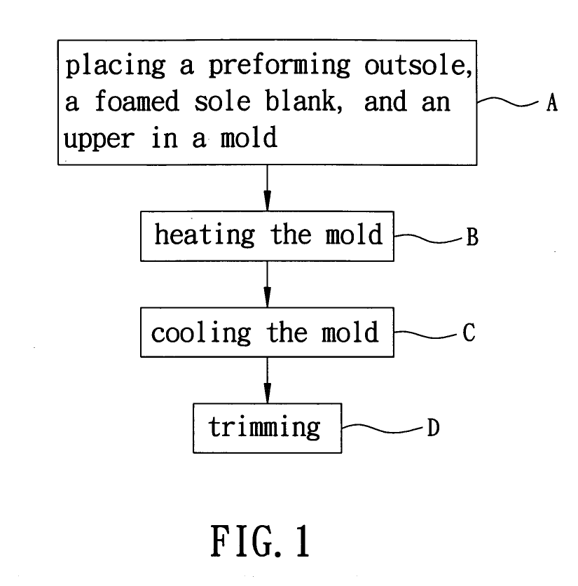

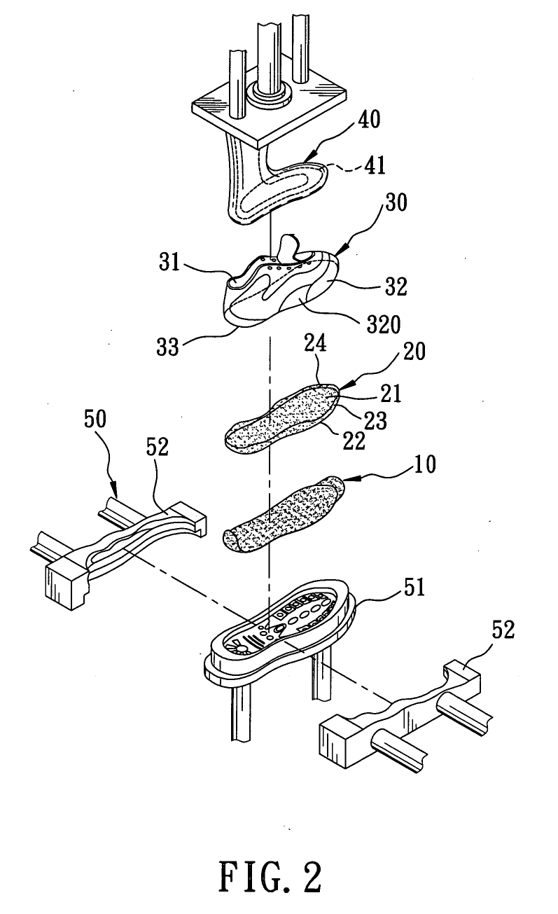

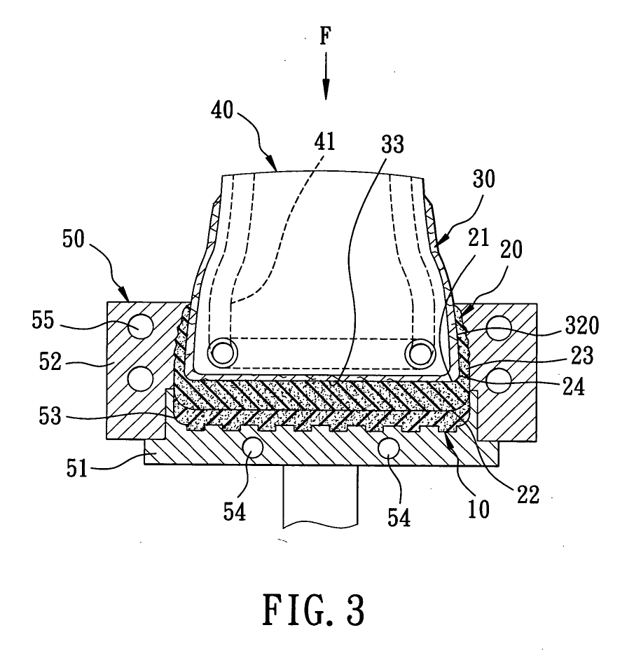

Referring to FIGS. 1, 2 and 3, the preferred embodiment of the method for making a shoe according to this invention comprises the steps of:

A) placing a preformed outsole, a foamed sole blank, and an upper in a mold:

A preformed outsole 10, a foamed sole blank 20, and an upper 30 are placed in a mold 50 in a manner that the upper 30 has a last 40 inserted therein and that the sole blank 20 is disposed between the upper 30 and the outsole 10. The last 40 is formed with a circulating passage 41 in the bottom portion thereof.

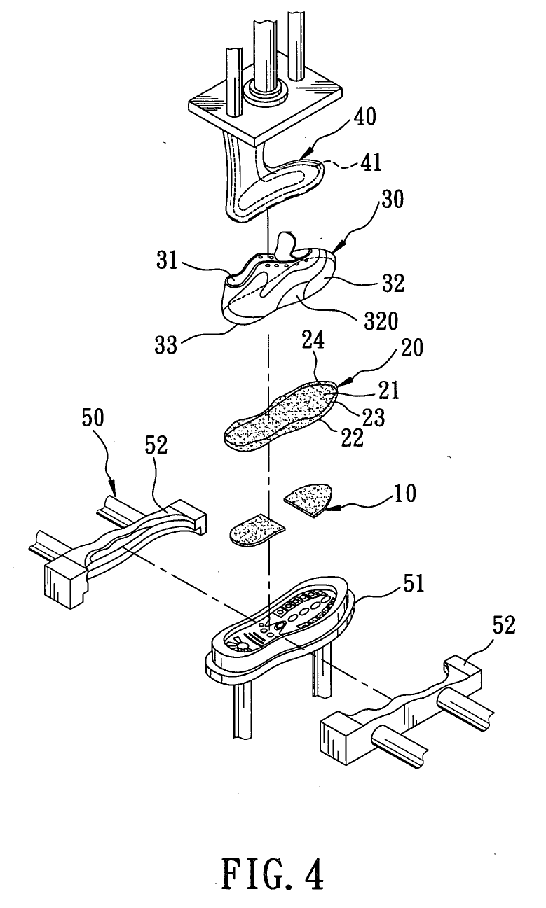

The preformed outsole 10 can be a singular outsole component, or can be composed of two separate outsole components (best shown in FIG. 4). Of course, the number of the outsole components can vary according to the specific requirement for the preformed outsole 10. The material for the preformed outsole 10 is rubber, thermoplastic urethane elastomer, or the like.

The foamed sole blank 20 is made of ethylene vinyl acetate copolymer, and includes a top surface 21, a bottom surface 22, and an upstanding peripheral edge 23 extending from a periphery of the top surface 21 so as to define a receiving space 24. The upstanding peripheral edge 23 extends around a lower part of the upper 30 when the sole blank 20 is placed in the mold 50. The sole blank 20 is larger than a sole of the shoe to be made by a volume of 12-45%. The upper 30 has a top opening 31, a bottom 33 which is to be disposed over the sole blank 20, and an outer surface 32 extending between the top opening 31 and the bottom 33. The outer surface 32 of the upper 30 has a peripheral bottom edge 320 extending upwardly from the bottom 33 of the upper 30.

The bottom 33 and the peripheral bottom edge 320 of the upper 30 and the outsole 10 are applied with adhesive (not shown in the figures). The top and bottom surfaces 21, 22 of the sole blank 20 are applied with a treating agent (not shown in the figures). The adhesive and the treating agent useful in this invention are well known in the art.

In practice, the upper 30 having the last 40 inserted therein, the sole blank 20, and the outsole 10 are altogether placed in the mold 50 at an ambient temperature. Alternatively, the sole blank 20 is preheated to a temperature ranging from 50 to 120° C., and is glued to the bottom 33 of the upper 30 sleeved on the last 40 before being placed in the mold 50. In another alternative, the last 40 is inserted into the upper 30, and the sole blank 20 is glued to the upper 30 sleeved on the last 40 and is preheated before the step of placing the outsole 10, the sole blank 20 and the upper 30 into the mold 50. In this preferred embodiment, the preformed outsole 10, the foamed sole blank 20, and the upper 30 are placed in the mold 50 by pressing the upper 30 sleeved on the last 50 against the sole blank 20 and the outsole 10 in the mold 50 under a pressing force (F) ranging from 15 to 75 kg/cm².

B) heating the Mold:

The mold 50 includes a main mold part 51, two opposite side mold parts 52 cooperating with the main mold part 51 to define a mold cavity 53, a main circulating passage 54 provided in the main mold part 51, and side circulating passages 55 provided in the side mold parts 52, respectively. The mold 50 is heated to a temperature ranging from 110 to 150° C. by passing a heating medium, such as hot water, from a heating device (not shown) through the main and side circulating passages 54,55. The last 40 is also heated by passing the heating medium through the circulating passage 41 when the mold 50 is heated. The time for heating the mold 50 is about 1-7 minutes when the mold 50 is heated to a temperature ranging from 110 to 150° C. Alternatively, when the sole blank 20 is preheated to a temperature ranging from 50 to 120° C., the time for heating the mold 50 can be shortened. Thereafter, the sole blank 20 is softened and bonded to the outsole 10 and the upper 30, and the sole blank 20 is formed into a shape of a sole of the shoe. It should be noted that the mold 50 can be heated by infra-red rays, electromagnetic waves, or other suitable heating means.

The pressing of the last 40 against the mold 50 when the mold 50 is heated facilitates the bonding of the sole blank 20 to the outsole 10 and the upper 30. Therefore, the peripheral edge 23 of the sole blank 20 can be bonded firmly to the peripheral bottom edge 320 of the upper 30.

c) Cooling the Mold:

The mold 50 is cooled by passing a cooling medium, such as cold water, through the main and side circulating passages 54, 55. At the same time, the last 40 can be cooled by passing the cooling medium through the circulating passage 41.

D) trimming:

The mold 50 is opened after the cooling step. The shoe thus produced is trimmed to obtain a final shoe product. The circulating passage 41 of the last 40, and the main and side circulating passages 54, 55 of the mold 50 are preheated once again by supplying the heating medium from the heating device in preparation for subsequent processing.

The outsole 10 can be made of a thermoplastic material, such as ethylene-vinyl acetate copolymer, trans-1,5-polypentenamer rubber, or the like, for providing for anti-slip and anti-abrasive effects.

Furthermore, a high resilient reinforcing sheet can be mounted under the sole blank 20 before the molding procedure so as to further improve the resiliency of the shoe.

In view of the aforesaid, the method of this invention has the following advantages:

1) Since the sole blank 20 is assembled with the outsole 10 and the upper 30 by direct thermal-molding in the method for making a shoe according to this invention, the problems encountered in the conventional injection molding technique for making a shoe can be avoided.

2) In the present method for making a shoe, the sole blank 20 is larger than a sole of the shoe to be made by a volume of 12-45%. Therefore, the sole will not be undersized due to shrinkage, and a desired density of the sole can be achieved.

3) The pressing of the last 40 against the mold 50 when the mold 50 is heated facilitates the bonding of the sole blank 20 to the outsole 10 and the upper 30. Therefore, the peripheral edge 23 of the sole blank 20 can be bonded firmly to the peripheral bottom edge 320 of the upper 30. The waterproof effect of the shoe can be improved thereby.

4) Additional components, such as a reinforcing sheet, a reinforcing strip or the like, can be added in the method for making a shoe according to this invention. Therefore, the method of this invention is flexible to meet the specific requirements.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for making a shoe, comprising the steps of:
a) placing a foamed sole blank and an upper in a mold, the upper being superimposed on the sole blank and having a last inserted therein;
b) heating the mold to a temperature ranging from 110 to 150° C. so that the sole blank is softened and bonded to the upper, and so that the sole blank is formed into a shape of a sole of the shoe; and
c) cooling the mold,
wherein the sole blank is larger than the sole by a volume of 12-45%.

2. The method as claimed in claim 1, further comprising a step of pressing the upper against the sole blank in the mold under a pressure ranging from 15 to 75 kg/cm².

3. The method as claimed in claim 1, wherein the sole blank includes an upstanding peripheral edge extending around a lower part of the upper when placed in the mold.

4. The method as claimed in claim 1, wherein the last is heated when the mold is heated.

5. The method as claimed in claim 1, wherein the last is cooled when the mold is cooled.

6. The method as claimed in claim 1, further comprising a step of preheating the sole blank to a temperature ranging from 50 to 120° C. before being placed in the mold.

7. The method as claimed in claim 1, further comprising the step of placing a preformed outsole in the mold below the sole blank during placement of the upper and the sole blank in the mold.

8. The method as claimed in claim 7, wherein the sole blank is glued to the upper before the outsole, the sole blank and the upper are put into the mold.

9. The method as claimed in claim 1, wherein the mold includes a main mold part, two opposite side mold parts cooperating with the main mold part to define a mold cavity, a main circulating passage provided in the main mold part, and side circulating passages provided in the side mold parts, respectively, and wherein the mold is heated by passing a heating medium through the main and side circulating passages.

10. The method as claimed in claim 7, wherein said preformed outsole is made of a thermoplastic material.

11. The method as claimed in claim 10, wherein the thermoplastic material is selected from the group consisting of ethylene-vinyl acetate copolymer and trans-1,5-polypentenamer rubber.
